(19) United States
(12) Patent Application Publication
(10) Pub. No.: US 2024/0173679 A1
(43) Pub. Date: May 30, 2024

(54) Gas Separation Membranes

(71) Applicants: Fujifilm Manufacturing Europe B.V., Tilburg (NL); Fujifilm Corporation, Tokyo (JP)

(72) Inventors: Shigehide Itoh, Tilburg (NL); Petrus Van Kessel, Tilburg (NL)

(21) Appl. No.: 18/284,147

(22) PCT Filed: Mar. 18, 2022
(86) PCT No.: PCT/EP2022/057109

§ 371 Date: Sep. 26, 2023

(30) Foreign Application Priority Data
Mar. 30, 2021 (GB) 2104462.3

(51) Int. Cl. B01D 71/70; B01D 53/22; B01D 67/00; B01D 69/02; B01D 69/10; B01D 69/12; B01D 69/14; B01D 71/82

(52) U.S. Cl. CPC B01D 71/70; B01D 53/228; B01D 67/0079; B01D 69/02; B01D 69/105; B01D 69/1214; B01D 69/1216; B01D 69/127; B01D 69/148; B01D 71/82; B01D 2323/12; B01D 2323/34; B01D 2325/04; B01D 2325/24; B01D 2325/28

(57) ABSTRACT

A gas separation membrane comprising the following layers: (i) a porous support layer; and (ii) a discriminating layer comprising groups of the Formula (1): M—(O—)ₓ, wherein: M is a metal or metalloid atom; O is an oxygen atom; and x has a value of at least 4; optionally (iii) a layer which comprises a fluorinated polymer; and optionally (iv) optionally a protective layer; wherein: (a) the porous support layer (i) comprises less than 10 mg/m² of monovalent metal ions; (b) the discriminating layer (ii) comprises a surface comprising at least 10 atomic % of M of Formula (1) groups, wherein M is as hereinbefore defined; and (c) when layer (iii) is present, layer (ii) is located between layers (i) and (iii).

This invention relates to gas separation membranes and to their preparation and use.

U.S. Pat. No. 10,427,111 describes gas separation membranes (GSMs) having high selectivity under high feeding pressure. The GSMs comprise a siloxane layer having a specified O/Si ratio on 10 nm depth. However U.S. Pat. No. 10,427,111 is silent about the ability of the membranes described therein to resist deformation under pressure.

One of the problems with currently available GSMs and modules containing them is that when they are used to separate polar gases from non-polar gases, their selectivity drops significantly over time. This problem is particularly acute when gas mixtures comprising polar and non-polar gases contact the GSMs under high humidity condition using high feeding pressures and temperatures. Under these circumstances the GSM often deforms (a problem often called ‘imprint), especially when the GSM is in contact with a macroporous spacer element which can ‘imprint’ or deform its pattern onto the GSM and thereby reduce the selectivity and/or gas separation efficiency of the GSM. There is a need for GSMs and modules containing them whose selectivity is maintained, or declines only slowly, when exposed to feed gas mixtures at high pressures and/or high temperatures.

According to a first aspect of the present invention there is provided a gas separation membrane comprising the following layers:
(i) a porous support layer;
(ii) a discriminating layer comprising groups of the Formula (1):

M—(O—)ₓ Formula (1)
wherein:
M is a metal or metalloid atom;
O is an oxygen atom; and
x has a value of at least 4;
optionally (iii) a layer which comprises a fluorinated polymer; and
optionally (iv) optionally a protective layer;
   wherein:
(a) the porous support layer (i) comprises less than 10 mg/m² of monovalent metal ions;
(b) the discriminating layer (ii) comprises a surface comprising at least 10 atomic % of M of Formula (1) groups, wherein M is as hereinbefore defined; and
(c) when layer (iii) is present, layer (ii) is located between layers (i) and (iii).

In this specification, the term “comprising” is to be interpreted as specifying the presence of the stated parts, steps or components, but does not exclude the presence of one or more additional parts, steps or components. Reference to an item by the indefinite article “a” or “an” does not exclude the possibility that more than one of the item(s) is present, unless the context clearly requires that there be one and only one of the items. The indefinite article “a” or “an” thus usually means “at least one”.

### BRIEF DESCRIPTION OF THE DRAWINGS

In the accompanying drawings:

FIG. 1 is a schematic vertical sectional view showing part of a conventional gas separation element comprising outer gas separation membranes and an inner, profiled macroporous sheet.

FIG. 2 is a schematic vertical sectional view showing the deformation of the membrane wall of the conventional gas separation membrane part of FIG. 1 caused at a high gas pressure

FIG. 3 is graph showing the atomic % of various components on a surface of discriminating layer (“DL”) of the gas separation membrane described in Comparative Example 1.

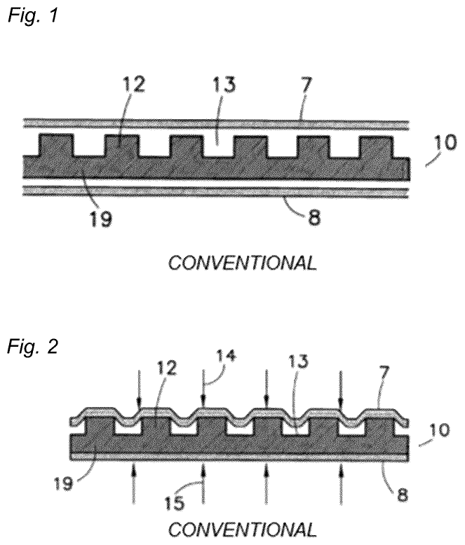

In FIG. 1 there is shown part of a conventional gas separation element used in a conventional gas separation module. In FIG. 1, the conventional gas separation element (10) comprises a first gas separation membrane (7), a second gas separation membrane (8) and a macroporous sheet (19) provided between these gas separation membranes. The macroporous sheet (19) has projections (12) and depressions (grooves) (13) formed alternately at constant intervals on the upper surface. The grooves form main channels for flow of permeate gas.

FIG. 2 is a schematic vertical sectional view showing the deformation (imprint) of the gas separation membrane (10) caused at a high pressure in the conventional gas separation element shown in FIG. 1. In FIG. 2, the feed gas flows above the first gas separation membrane (7) and below the second gas separation membrane (8), and partially permeates the gas separation membranes (7) and (8) to reach the macroporous sheet (19). In this case, if the feed gas is supplied at a high pressure, the first gas separation membrane (7) located on the rough side of the macroporous sheet (19) is partially depressed into the grooves (13), and is deformed/imprinted. The pressure acting on the first gas separation membrane (7) is indicated by arrows (14), and the pressure acting on the second gas separation membrane (8), by arrows (15). The deformation of the first gas separation membrane (7) partially closes the grooves (13) which are main pathway for the flow of gas which has permeated through the membrane (7). Furthermore, the deformation (imprint) damages the first gas separation membrane (7), thereby lowering the performance of the gas separation membrane (7) such as lowering the membrane's separation selectivity especially the separation of polar and non-polar gases (e.g. separation of higher alkanes such as C₄H₁₀ and CO₂ from mixtures containing both.

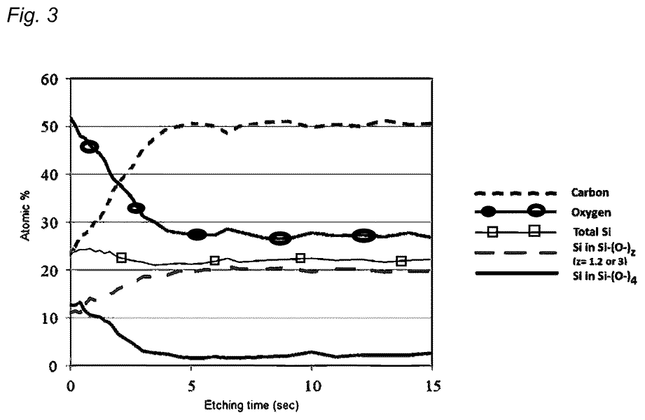

In FIG. 3 was obtained by analysing the DL from Comparative Example 1 (before other layers had been added on top) of the present invention using ULVAC-PHI surface analysis equipment. The horizontal axis indicates the Argon Gas cluster ion beam (Ar-GCIB) sputter time (indicating the depth being analysed) and the vertical axis indicates the atomic % of each element detected at that depth. In order from top to bottom, the 5 lines on the graph in FIG. 3 show the atomic % of carbon, oxygen, total silicon, silicon present in compounds of Formula (2) and silicon present in compounds of Formula (1) respectively. One can see from the left hand side of FIG. 3 that the atomic % of Si of Si—(O—)₄ of a surface of the DL is at least 10%. Furthermore, the atomic % of Si of Si—(O—)₄ in the DL declines with increasing distance from that surface.

The layer (i) preferably comprises less than 7 mg/m² of monovalent metal ions, more preferably less than less than 5 mg/m² of monovalent metal ions. In one embodiment the layer (i) is free from or essentially free from monovalent metal ions, e.g. no monovalent metal ions can be detected in the porous support. In another embodiment, layer (i) comprises at least 0.1 mg/m², for example at least 0.5 mg/m² of monovalent metal ions. By keeping the monovalent ions below the 10 mg/m² in layer (i) the selectivity of the gas separation membrane surprisingly remains good even under humid conditions.

Preferably layer (i) comprises a porous sheet material. The porous sheet material proves the GSM with mechanical strength and reduces the likelihood of the GSM being damaged when used at high pressures and/or temperatures.

Preferred porous support sheet materials include, for example, woven and non-woven fabrics and combinations thereof.

The porous sheet material may be constructed from any suitable polymer or natural fibre. Examples of such polymers include polysulfones, polyethersulfones, polyimides, polyetherimides, polyamides, polyamideimides, polyacrylonitrile, polycarbonates, polyesters, polyacrylates, cellulose acetate, polyethylene, polypropylene, polyvinylidenefluoride, polytetrafluoroethylene, poly(4-methyl 1-pentene) and especially polyacrylonitrile.

Many suitable porous sheet materials are commercially available. Alternatively one may prepare the porous sheet material using techniques generally known in the art for the preparation of such materials. In one embodiment one may prepare the optional porous sheet material by curing curable components, e.g. in an analogous manner to that used to prepare membranes which have pores too large to discriminate between different gases. Optionally the porous sheet material may be subjected to a corona discharge treatment, glow discharge treatment, flame treatment, ultraviolet light irradiation treatment or the like, e.g. for the purpose of improving its wettability and/or adhesiveness.

As porous sheet material one may use an ultrafiltration membrane, e.g. a polysulfone ultrafiltration membrane, cellulosic ultrafiltration membrane, polytetrafluoroethylene ultrafiltration membrane, polyvinylidenefluoride ultrafiltration membrane and especially polyacrylonitrile ultrafiltration membrane. Asymmetric ultrafiltration membranes may also be used, including those comprising a porous polymer membrane (preferably of thickness 10 to 150 μm, more preferably 20 to 100 μm) and optionally a woven or non-woven fabric support.

The porous sheet material is preferably as thin as possible, provided it retains the desired structural strength.

Preferably the porous sheet material (“PSM”) comprises pores having an average diameter of 0.001 to 10 μm, preferably 0.01 to 1 μm (i.e. before the PSM has been converted into a gas separation membrane). Preferably the PSM comprises pores which, at the surface have an average diameter of 0.001 to 0.1 μm, preferably 0.005 to 0.05 μm. The average pore diameter may be determined by, for example, viewing the surface of the porous sheet material by scanning electron microscopy (“SEM”) or by cutting through the PSM and measuring the diameter of the pores within the porous support, again by SEM, then calculating the average.

The porosity at the surface of the PSM may also be expressed as a % porosity i.e.

$$\% porosity = 100 \% \times \frac{( area of the surface which is missing due to pores )}{( total surface area )}$$

The areas required for the above calculation may be determined by inspecting the surface of the PSM before it has been converted into a gas separation membrane by SEM. Thus, in a preferred embodiment, the PSM has a % porosity >1%, more preferably >3%, especially >10%, more especially >20%.

Alternatively the porosity of the PSM may be characterised by measuring the N₂ gas flow rate through the PSM. Gas flow rate can be determined by any suitable technique, for example using a Porolux™ 1000 device, available from Porometer.com. Typically the Porolux™ 1000 is set at the maximum pressure (about 34 bar) and one measures the flow rate (L/min) of N₂ gas through the porous sheet material under test. The N₂ flow rate through the PSM at a pressure of about 34 bar for an effective sample area of 2.69 cm² (effective diameter of 18.5 mm) is preferably >1 L/min, more preferably >5 L/min, especially >10 L/min, more especially >25 L/min. The higher of these flow rates are preferred because this reduces the likelihood of the gas flux of the resultant membrane being reduced by the porous sheet material. The above pore sizes and porosities refer to the PSM before it has been converted into the GSM of the present invention.

The porosity of layer (i) (as a whole) may be expressed as a CO₂ gas permeance (units are m³(STP)/m²·s·kPa). When the GSM is intended for use in gas separation then layer (i) preferably has a CO₂ gas permeance of 5 to 150×10⁻⁵ m³(STP)/m²·s·kPa, more preferably of 5 to 100, most preferably of 7 to 70×10⁻⁵ m³(STP)/m²·s·kPa.

Layer (i) (as a whole) preferably has an average thickness of 20 to 500 μm, preferably 50 to 400 μm, especially 100 to 300 μm.

Preferably layer (i) further comprises a gutter layer(“GL”). When layer (i) comprises a gutter layer, the gutter layer is preferably located between the porous sheet material and layer (ii).

Preferably layer (i) further comprises a resin precursor layer. When layer (i) comprises a resin precursor layer, the resin precursor layer (“RPL”) is preferably located between the porous sheet material and layer (ii).

When layer (i) comprises a porous sheet material, a gutter layer and a resin precursor layer, it is preferred that the gutter layer is located between the support sheet material and the resin precursor layer. Furthermore, in this embodiment it is preferred that the resin precursor layer is located between the gutter layer and layer (ii).

The total atomic % of M present in a surface of the discriminating layer (“DL”) includes M from all sources and not just from the compound of Formula (1) but may include other sources of M such as compound of Formula (2)

M—(O—)_{z} Formula (2)

wherein:
M is a metal or metalloid atom;
O is an oxygen atom; and
z has a value of 1, 2 or 3.

Typically the DL comprises groups of Formula (1) and groups of Formula (2). Preferably, however, the DL comprises a greater mass of groups of Formula (1) than groups of Formula (2).

When the DL contains groups of Formula (2), preferably M in Formula (1) is the same metal or metalloid as M in Formula (2).

Preferably each M independently is silicon, titanium, zirconium or aluminium. M is preferably silicon, titanium, zirconium and/or aluminium.

Preferably the DL comprises less than 50 atomic % of M of Formula (1) groups.

When M is silicon a surface of the DL preferably comprises 10 to 30 atomic % of M of Formula (1) groups.

When M is aluminium a surface of the DL preferably comprises 10 to 40 atomic % of M of Formula (1) groups.

When M is titanium a surface of the DL preferably comprises 10 to 30 atomic % of M of Formula (1) groups.

When M is zirconium a surface of the DL preferably comprises 10 to 30 atomic % of M of Formula (1) groups.

The atomic % of M of Formula (1) or Formula (2) in a surface of the DL may be determined using surface analysis equipment, for example by X-ray photoelectron spectroscopy (XPS) (e.g. using GC-IB/XPS Gas cluster ion beam XPS). Such equipment may also be used to determine the atomic % of M at different depths below the surface of the DL. A suitable piece of equipment for performing surface analysis to determine the atomic % of M in the DL is the VersaProbe II XPS apparatus from Physical Electronics, Inc. (“ULVAC-PHI”). The ULVAC-PHI is preferably set up with monochromated Al K_{α} (1486.6 eV, 15 W 25 KV 100 μmφ, raster size 300 μm×300 μm) X-ray source. For charge compensation, low energy electron and Ar ion may be flooded during measurement of the atomic % of M in the DL. Ar gas cluster beam (5 kV, 20 nA, 2mm×2mm) may be used for depth profile analysis. From this analysis, the atomic % of M and any other elements present in the DL (e.g. carbon and oxygen) may be measured. At the data point which has the highest atomic % of M, the atomic % of M in the DL can be determined. This will include M from all sources such as groups of the Formula (1) or Formula (2) as defined above and the amount of M in each of these groups can be quantified separately. For example, when M is silicon, the atomic % of silicon in Si—(O—)₄ and Si—(O—)_{Z} (wherein z is 1, 2 or 3) can be quantified by this method. In the spectrum of Si2p, the bonding energy at 102.6 eV is defined as being a group of Formula (2), whereas the bonding energy of 103.8 eV is defined as being a group of Formula (1), wherein Formula (1) and Formula (2) are as hereinbefore defined. The area ratio of Si2p at 102.6 eV and at 103.8 eV may be converted to an atomic ratio (atomic %) so that the total of the separated peak components area would corresponds to the atomic % of Si.

In one embodiment, the DL comprises a surface comprising at least 10 atomic % of M of Formula (1) groups and the atomic % of M of Formula (1) groups present in the DL declines as the distance in the DL from that surface increases, optionally to atomic % of M below 10, wherein M is as hereinbefore defined. This can be seen in FIG. 3.

In one embodiment layer (ii) is obtainable or obtained by a process comprising plasma deposition of M in the form of groups of Formula (1) and optionally also groups of Formula (2) (as hereinbefore defined). A suitable deposition process comprises plasma deposition, especially plasma deposition of compounds comprising M such that a DL comprising groups of Formula (1) and optionally also groups of Formula (2) (as hereinbefore defined) is formed. Preferred plasma deposition processes are performed using an atmosphere comprising air, or oxygen, optionally in the presence of precursors.

In another embodiment the DL (i.e. layer (ii)) is obtainable or obtained by a process comprising plasma treatment of layer (i), particularly in the presence of oxygen and optionally an inert gas (e.g. argon and or nitrogen). For example, where layer (i) comprises a polysiloxane (e.g. as GL), plasma treatment of the polysiloxane of layer (i) may be used to convert a part (e.g. surface) of layer (i) into layer (ii) as defined above wherein M is silicon. In this embodiment there is no need to add precursors to the plasma because, in effect, the polysiloxane layer (GL) provides the precursor. In a preferred embodiment layer (ii) comprises silica and a polysiloxane. The groups of Formula (1), and also groups of Formula (2) when present (as hereinbefore defined and preferred), are present in layer (ii).

In one embodiment, layer (ii) is applied to layer (i) by a plasma treatment process using a precursor material for the compound of Formula (1) and, as gas, O₂ alone or a mixture in which the only gases are O₂ noble gasses (e.g. argon) as described in U.S. Pat. No. 10,427,111, page 40, line 4 to page 41, line 36, which is included herein by reference thereto. Layer (ii) is then coated onto layer (i).

The plasma treatment process for applying layer (ii) to layer (i) is preferably performed at an energy level in the range of 0.30-9.00 J/cm² (and using low pressure or even at (remote) atmospheric plasma treatment).

The plasma treatment process for applying layer (ii) to layer (i) is preferably performed using a flow rate of argon in the range of 5 to 500 cm³(STP)/min, more preferably in a range of 50 to 200 cm³(STP)/m in, and particularly preferably in a range of 80 to 120 cm³(STP)/min. The flow rate of oxygen (or air) is preferably 10 cm³(STP)/min, preferably in a range of 10 to 100 cm³(STP)/min, more preferably in a range of 15 to 100 cm³(STP)/min, and particularly preferably in a range of 20 to 50 cm³(STP)/min. The low pressure plasma treatment is preferably performed at a gas pressure in the range of 0.6 Pa to 100 Pa, more preferably in a range of 1 to 60 Pa, and particularly preferably in a range of 2 to 40 Pa.

When a precursor is used in the plasma treatment which comprises silica this results in the deposition of layer (ii) onto layer (i) as a silica-like top-surface comprising groups of Formula (1) and usually also groups of Formula (2), both as hereinbefore defined.

The average thickness of layer (ii) is typically in the range of 1 to 150 nm, more preferably 5 to 120 and even more preferably 10 to 100 nm.

Typically the concentration of groups of Formula (1) gradually decreases from the top to layer (ii) downwards. This can be seen in FIG. 3 where the atomic % of Si—(O—)₄ is above 10 at the surface of layer (ii) (i.e. low etching time) and reduces as the depth increases (higher etching time). The concentration of the atoms present in membrane at various depths can be accurately measured by using surface analysis equipment, for example by X-ray photoelectron spectroscopy (XPS) (e.g. using GC-IB/XPS Gas cluster ion beam XPS), as described in more detail above. For example, when M is Si, the amount of groups of Formula (1) and Formula (2) can be quantified using surface analysis equipment. In the spectrum of Si2p, the bonding energy at 102.6 eV corresponding to groups of Formula (2) (Si—(O—)_{z} (z=1, 2 or 3) and 103.8 eV corresponding to groups of Formula (1) (Si—(O—)₄). The area ratio of 102.6 eV and 103.8 eV may be converted to provide the atomic % of Si. In FIG. 3, the atomic % of Si in Si—(O—)₄ from Example 1 was found to be above 10%.

According to a second aspect of the present invention there is provided a process for forming a gas separation membrane according to the first aspect of the present invention comprising the steps of forming a discriminating layer (ii) comprising groups of Formula (1) (as hereinbefore defined) and optionally groups of Formula (2) (as hereinbefore defined) on a porous support (i) by a plasma treatment process and the step of forming a layer (iii) on the discriminating layer layer (ii) wherein layer (iii) has an average thickness of between 50 and 500 nm and comprises a fluorinated polymer.

In one preferred embodiment, layer (ii) is obtained using atmospheric pressure glow discharge plasma. For example, layer (i) may be exposed to an atmospheric pressure glow discharge plasma thereby forming layer (ii).

The atmospheric pressure glow discharge plasma is preferably generated in a treatment space at an effective power density of 0.1 up to 30 W/cm², and exposing the surface of layer (i) to the atmospheric pressure glow discharge plasma in the treatment space for less than 60 seconds, in which the atmospheric pressure glow discharge plasma is generated in an inert gas (e.g. argon or nitrogen) or oxygen-containing atmosphere (e.g. oxygen or air) in the treatment space.

The atmospheric pressure glow discharge plasma is performed with a precursor compound (especially an organosilicon compound) present in the treatment space and is performed at an energy of 0.1 to 10 J/cm².

In a preferred embodiment, the atmospheric pressure glow discharge plasma is performed in an atmosphere of air.

In a preferred embodiment, an atmospheric pressure glow discharge plasma can be stabilized according to methods described in for example U.S. Pat. No. 6,774,569 or EP1383359.

In still a further embodiment layer (i) is exposed to an atmospheric pressure glow discharge plasma, wherein the plasma is stabilized by an inductance and capacitance (LC) matching network like for example described in EP1917842. This embodiment provides a very uniform and rich layer of groups of Formula (1).

In another embodiment, layer (ii) may be applied to layer (i) using a plasma treatment in a low pressure plasma environment as described in U.S. Pat. No. 10,427,111.

The plasma treatment is preferably performed using a plasma treatment apparatus comprising a first electrode and a second electrode for generating an atmospheric pressure glow discharge plasma in a treatment space between the first and second electrode. The electrodes can be provided with a dielectric barrier in various arrangements. In one arrangement the dielectric barrier of at least one electrode is formed by a polymer film or inorganic dielectric. Such as polymer like polyethylene terephthalate (PET), polytetrafluoroethylene (PTFE) or polyethylene (PE) or ceramic such as silica or alumina, or combinations of these, also microporous dielectric materials attached to the electrodes can be used.

The plasma treatment apparatus may, in a further embodiment, comprise a transport device for transporting layer (i) over the electrode. Also, the transport device may comprise a tensioning mechanism for keeping layer (i) in close contact with the electrode.

In one embodiment the process according to the second aspect of the present invention preferably forms the discriminating layer (ii) from precursors (also called precursor compounds). Precursors which may be used to provide groups of Formula (1) (as hereinbefore defined) and optionally groups of Formula (2) (as hereinbefore defined) include TEOS (tetraethyl orthosilicate), HMDSO (hexamethyldisiloxane), TMOS (tetramethyl orthosilicate), TMCTS (1,3,5,7-tetramethylcyclotetrasiloxane), D4 OMCTS (octamethyl cyclotetrasiloxane), D5 (decamethylcyclopentasiloxane), D6 (dodecamethylcyclohexasiloxane), silane (SiH₄), TPOT (tetrapropylorthotitanate), TEOT (titanium ethoxide), TITP (titanium tetraisopropoxide), ZTB (zirconium tetra-tert-butoxide), Zr(N(C₂H₅)₂)₄ or (Cp)Zr(N(CH₃)₂)₃ or TMA (trimethylaluminium) and mixtures comprising two or more thereof.

The groups of Formula (1) (as hereinbefore defined) and optionally groups of Formula (2) (as hereinbefore defined) may be derived from a precursor in the presence of O₂, e.g. in the form of air. The groups of Formula (1) (as hereinbefore defined) and optionally groups of Formula (2) (as hereinbefore defined) are deposited on layer (i). By using the atmospheric pressure glow discharge equipment as described in EP1917842 using an inductance and capacitance (LC) matching network an uniform discriminating layer (ii) can be prepared, preferably of average thickness between 10 and 100 nm and with an atomic % of M of M—(O—)x (Formula (1) groups) of at least 10% (e.g. 10 to <50 atomic %).

Thus in one embodiment of the process according to the second aspect of the present invention the discriminating layer (ii) comprising the groups of Formula (1) (and optionally the groups of Formula (2)) is formed from plasma treatment of layer (i). In another embodiment of the process according to the second aspect of the present invention the discriminating layer (ii) comprising the groups of Formula (1) (and optionally the groups of Formula (2)) is formed by deposition onto the porous support (i), preferably using a precursor compound.

As mentioned above, layer (i) preferably comprises a gutter layer (“GL”). The GL, when present, is preferably attached to the porous support sheet.

The GL is permeable to gasses, although typically the GL has a low ability to discriminate between gases. The GL, when present, preferably comprises a polymer resin, especially a polysiloxane.

Preferably the polysiloxane present in or as the GL is a poly(dimethyl)siloxane, e.g. a polymer comprising an —Si—(CH₃)₂—O— repeat unit’

The GL preferably has an average thickness 50 to 1200 nm, preferably 150 to 800 nm especially 200 to 650 nm.

Preferably the GL comprises groups which are capable of bonding to a metal, for example by covalent bonding, ionic bonding and/or by hydrogen bonding, preferably by covalent bonding. The identity of such groups depends to some extent on the chemical composition of the GL and the identity of the metal, but typically such groups are selected from epoxy groups, oxetane groups, carboxylic acid groups, amino groups, hydroxyl groups, vinyl groups, hydrogen groups and thiol groups. More preferably the GL comprises a polymer having carboxylic acid groups, epoxy groups or oxetane groups, vinyl groups, hydrogen groups, or a combination of two or more of such groups. Such a polymer may be formed on the support by a process comprising the curing of a radiation-curable or heat-curable composition, especially a curable (e.g. radiation-curable) composition comprising a polymerisable dialkylsiloxane. The latter option is useful for providing GLs comprising dialkylsiloxane groups, which are preferred.

The polymerisable dialkylsiloxane is preferably a monomer comprising a dialkylsiloxane group or a polymerisable oligomer or polymer comprising dialkylsiloxane groups. For example, one may prepare the GL from a radiation-curable composition comprising a partially crosslinked, radiation-curable polymer comprising dialkylsiloxane groups, as described in more detail below. Typical dialkylsiloxane groups are of the formula —{O—Si(CH₃)₂}n- wherein n is at least 1, e.g. 1 to 100. Poly(dialkylsiloxane) compounds having terminal vinyl groups are also available and these may be incorporated into the GL by the curing process.

In one embodiment the GL is free from groups of formula Si—C₆H₅.

Irradiation of the radiation-curable composition (sometimes referred to as “curing” in this specification) may be performed using any source which provides the wavelength and intensity of radiation necessary to cause the radiation-curable composition to polymerise and thereby form the GL on the porous sheet material. For example, electron beam, ultraviolet (UV), visible and/or infrared radiation may be used to irradiate (cure) the radiation-curable composition, with the appropriate radiation being selected to match the components of the composition.

The optional gutter layer is preferably obtained from curing a curable composition comprising:
(1) 0.5 to 25 wt % of radiation-curable component(s), at least one of which comprises dialkylsiloxane groups;
(2) 0 to 5 wt % of a photo-initiator; and
(3) 70 to 99.5 wt % of inert solvent.

Preferably the curable composition used to prepare the GL has a molar ratio of metal:silicon of at least 0.0005, more preferably 0.001 to 0.1 and especially 0.003 to 0.03.

The radiation-curable component(s) of component (1) typically comprise at least one radiation-curable group. Radiation curable groups include ethylenically unsaturated groups (e.g. (meth)acrylic groups (e.g. CH₂═CR¹—C(O)— groups), especially (meth)acrylate groups (e.g. CH₂═CR¹—C(O)— groups), (meth)acrylamide groups (e.g. CH₂═CR¹—C(O)NR¹— groups), wherein each R¹ independently is H or CH₃) and especially oxetane or epoxide groups (e.g. glycidyl and epoxycyclohexyl groups).

The amount of radiation-curable component(s) present in the curable composition used to prepare the GL and/or the optional protective layer (i.e. component (1)) is preferably 1 to 20 wt %, more preferably 2 to 15 wt %. In a preferred embodiment, component (1) of the curable composition used to prepare the GL and/or protective layer comprises a partially crosslinked, radiation-curable polymer comprising dialkylsiloxane groups.

The function of the inert solvent (3) is to provide compositions with a viscosity suitable for the particular method used to apply the curable composition to the support. For high speed application processes one will usually choose an inert solvent of low viscosity. Examples of suitable inert solvents are mentioned above in relation to preparation of the polymer sheet.

The amount of inert solvent (3) present in the curable composition used to prepare the GL and/or protective layer (i.e. component (3)) is preferably 70 to 99.5 wt %, more preferably 80 to 99 wt %, especially 90 to 98 wt %.

Inert solvents are not radiation-curable.

The compositions may contain other components, for example surfactants, surface tension modifiers, viscosity enhancing agents, biocides and/or other components capable of co-polymerisation with the other ingredients.

In some embodiments it is advantageous to include a resin precursor layer (“RPL”) in layer (i), typically on the GL or, when layer (i) does not comprise a GL, on the porous sheet material. The RPL can be prepared by applying a composition comprising a cross-linkable polysiloxane polymer on the optional GL or, when layer (i) does not comprise a GL, on the porous sheet material, and subsequently cross-linking the resin precursor of the RPL.

Preferably the RPL has an average thickness of 2 to 1000 nm, more preferably 10 to 500 nm, especially preferably 20 to 200 nm.

Preferably the RPL comprises a cross-linked polymer, preferably a cross-linked polymer formed by cross-linking a composition comprising a resin comprising —O—Si≡CH and —O—Si(CH₃)₂CH—CH₂ groups, e.g. a QM-resin, which is a type of siloxane which comprising groups of Formula (Q) shown below (in addition to —O—Si≡CH and —O—Si(CH₃)₂CH—CH₂ groups):

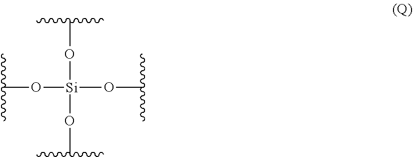 [SMILES: *O[Si](O*)(O*)O*]

In a preferred embodiment the RPL comprises groups of the following formula:

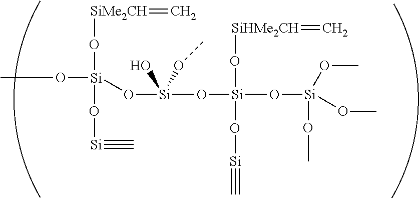

In the most preferred embodiment the concentration of the resin comprising —O—Si≡CH and —O—Si(CH₃)₂CH—CH₂ groups in the RPL is between 5 and 60 wt % versus the total amount of polymer in the RPL.

The RPL can be cross-linked by any method known in the art. Preferred cross-linking methods include, but are not limited to hydrosylilation cure, peroxide cure, dehydrogenative cure, moisture cure, condensation cure or radiation cure. Preferred radiation cure methods include, but are not limited to free radical UV cure, cationic UV cure, UV initiated hydrosylilation cure, gamma-ray cure or thiol-ene UV cure.

The hydrosililation cure preferably uses a hydrosiloxane, e.g. a poly(alkylhydrosiloxane-co-dimethylsiloxane), for example poly(methylhydrosiloxane-co-dimethylsiloxane).

Preferred catalysts for use in hydrosililation cure include, but are not limited to hexachloroplatinic acid (Speyer's catalyst), Platinum(O)-1,3-divinyl-1,1,3,3-tetramethyldisiloxane complex (Karstedt's catalyst), Platinum carbonyl cyclovinylmethylsiolxane complex, Platinum cyclovinylmethylsiolxane complex, Platinum-octanaldehyde/octanol complex or tris(dibutylsulfide)Rhodium trichloride.

Preferred inhibitors for use in hydrosililation cure include, but are not limited to 2-Methyl-3-butyn-2-ol, 1-Ethynyl-1-cyclohexanol, 3-Butyn-2-ol, 3-Butyn-1-ol or 3-Methyl-1-pentyn-3-ol.

Preferred catalysts for use in peroxide cure include, but are not limited to dicumyl peroxide, di(t-butylperoxy)diisopropylbenzene, 2,5-dimethyl-2,5-di(t-butylperoxy)hexane, 2,5-dimethyl-2,5-di(t-butylperoxy)hexyne, 2,4-dichlorobenzoyl peroxide, 1,2-bis(t-butylperoxy)3,3,5-trimethylcyclohexane or n-butyl-4,4-di(t-butylperoxy)valerate.

Preferred photo-initiators for use in free radical UV cure include, but are not limited to Radical Type I and/or type II photo-initiators.

Examples of radical type I photo-initiators are as described in WO 2007/018425, page 14, line 23 to page 15, line 26, which are incorporated herein by reference thereto.

Examples of radical type II photo-initiators are as described in WO 2007/018425, page 15, line 27 to page 16, line 27, which are incorporated herein by reference thereto. In case radical type II photo-initiators are used, preferably a synergist is also added. Preferred examples of synergists include, but are not limited to triethylamine, triethanolamine, methyl diethanolamine, ethyl 4-(dimethylamino)benzoate, 2-butoxyethyl 4-(dimethylamino)benzoate, 2-prop-2-enoyloxyethyl 4-(dimethylamino)benzoate and 2-ethylhexyl 4-(dimethylamino)benzoate.

For resin RPLs comprising one or more (meth)acrylate group, type I photo-initiators are preferred. Especially alpha-hydroxyalkylphenones, such as 2-hydroxy-2-methyl-1-phenyl propan-1-one, 2-hydroxy-2-methyl-1-(4-tert-butyl-) phenylpropan1-one, 2-hydroxy-[4′-(2-hydroxypropoxy)phenyl]-2-methylpropan-1-one, 2-hydroxy-1-[4-(2-hydroxyethoxy)phenyl]-2-methyl propan-1-one, 1-hydroxycyclohexylphenylketone and oligo[2-hydroxy-2-methyl-1-{4-(1-methylvinyl)phenyl}propanone], alpha-aminoalkylphenones, alpha-sulfonylalkylphenones and acylphosphine oxides such as 2,4,6-trimethylbenzoyl-diphenylphosphine oxide, ethyl-2,4,6-trimethylbenzoylphenylphosphinate and bis(2,4,6-trimethylbenzoyl)-phenylphosphine oxide, are preferred.

Preferably the weight ratio of photo-initiator to radiation-curable components present in the RPL is between 0.001 and 0.2 to 1, more preferably between 0.01 and 0.1 to 1.

In case the cross-linking is performed by thiol-ene UV cure, the preferred photo-initiators are the same as described above for the use in free radical cure. An added advantage of the use of thiol-ene cure is that in case a type II photo-initiator is applied, a synergist is not required.

Preferred photo-initiators for use in cationic UV cure include, but are not limited to organic salts of non-nucleophilic anions, e.g. hexafluoroarsinate anion, antimony (V) hexafluoride anion, phosphorus hexafluoride anion, tetrafluoroborate anion and tetrakis (2,3,4,5,6-pentafluorophenyl)boranuide anion, (4-phenylthiophenyl)diphenylsulfonium triflate; triphenylsulfonium triflate; Irgacure(R) 270 (available from BASF); triarylsulfonium hexafluoroantimonate; triarylsulfonium hexafluorophosphate; CPI-100P (available from SAN-APRO); CPI-210S (available from SAN-APRO) and especially Irgacure(R) 290 (available from BASF), CPI-100P from San-Apro Limited of Japan, triphenylsulphonium hexafluorophosphate, triphenylsulphonium hexafluoroantimonate, triphenylsulphonium tetrakis(pentafluorophenyl)borate, 4,4′-bis[diphenylsulphonio]diphenylsulfide bishexafluorophosphate, 4,4′-bis[di(beta-hydroxyethoxy)phenylsulphonio]diphenylsulfide bishexafluoroantimonate, 4,4′-bis[di(beta-hydroxyethoxy)phenylsulphonio]diphenylsulfide bishexafluorophosphate, 7-[di(p-toluyl)sulphonio]-2-isopropylthioxanthone hexafluoroantimonate, 7-[di(p-toluyl)sulphonio]-2-isopropylthioxanthone tetrakis(pentafluorophenyl)borate, 4-phenylcarbonyl-4′-diphenylsulphonio-diphenylsulphide hexafluorophosphate, 4-(p-tert-butylphenylcarbonyl)-4′-diphenylsulphonio-diphenylsulphide hexafluoroantimonate, and 4-(p-tert-butylphenylcarbonyl)-4′-di(p-toluyl)sulphonio-diphenylsulphide tetrakis(pentafluorophenyl)borate (e.g. DTS-102, DTS-103, NDS-103, TPS-103, MDS-103 from Midori Chemical Co. Ltd.), phenyliodonium hexafluoroantimonate (e.g. CD-1012 from Sartomer Corp.), diphenyliodonium tetrakis(pentafluorophenyl)borate, diphenyliodonium hexafluorophosphate, diphenyliodonium hexafluoroantimonate, bis(dodecylphenyl)iodonium hexafluoroantimonate, and di(4-nonylphenyl)iodonium hexafluorophosphate, MPI-103, BBI-103 from Midori Chemical Co. Ltd., certain iron salts (e.g. Irgacure™ 261 from Ciba), 4-isopropyl-4′-methyldiphenyliodonium tetrakis(pentafluorophenyl) borate ((C40H18BF20I)) available under the name I0591 from TCI) and 4-(octyloxy)phenyl](phenyl) iodonium hexafluoroantimonate (C20H26F6IOSb, available as AB153366 from ABCR GmbH Co).

In case the cross-linking is performed by gamma-ray then the curing can be achieved without the use of a catalyst or photo-initiator.

The RPL is preferably obtained from curing a curable composition comprising:
(4) 0.5 to 10 wt % of QM-resin;
(5) 0.05 to 5 wt % of hydrosiloxane;
(6) 0.001 to 2 wt % of a catalyst;
(7) 0.001 to 2 wt % of inhibitor;
(8) 70 to 99.5 wt % of inert solvent.

In a preferred embodiment both the GL and the RPL are obtained as described above. In other words, layer (i) comprises a porous sheet material, the GL is present on the porous sheet material (e.g. the GL is applied to the porous sheet material, e.g. as a polysiloxane coating) and the RPL is present on the GL (e.g. the precursor resin layer is applied to the GL). Then layer (ii) is applied to the topmost layer (in this case the RPL) (e.g. from a precursor) or layer (ii) is formed from the topmost layer, e.g. by plasma treatment of an RPL containing polysiloxane groups in the presence of oxygen.

Preferably the surface of the DL comprising at least 10 atomic % of M of M—(O—)ₓ in Formula (1), wherein M is as hereinbefore defined, is in contact with layer (iii).

Preferably, the fluorinated polymer present in layer (“FPL”) (iii) comprises one or more perfluorinated polymers, especially one or more an amorphous perfluorinated polymers. Preferably layer (iii) consists of one or more perfluorinated polymers.

Preferred perfluorinated polymers include poly[4,5-difluoro-2,2-bis(trifluoromethyl)-1,3-dioxole-co-tetrafluoroethylene] having 60 to 90 mol % of dioxole, preferably 87 mol % of dioxole (available from Chemous as TEFLON® AF 2400), poly[4,5-difluoro-2,2-bis(trifluoromethyl)-1,3-dioxole-co-tetrafluoroethylene] having 50 to 80 mol % of dioxole, preferably 65 mol % of dioxole (available from Chemous as TEFLON® AF 1600), a perfluorinated polymer from the CYTOP® series (from AGC Chemicals Company), and amorphous poly(tetrafluoroethylene-co-2,2,4-trifluoro-5-trifluoromethoxy-1,3-dioxole), preferably having a proportion of ether functionalities of 30 to 90 mol %, preferably 40, 60 or 80 mol % (available, for example, from Solvay as HYFLON® AD 60 or HYFLON® AD 40H).

Layer (iii) preferably has an average thickness of at least 50 nm. Preferably layer (iii) has an average thickness of 500 nm or less. In a preferred embodiment, layer (iii) has an average thickness of 50 to 500 nm, more preferable from 60 to 400 nm and even more preferred from 70 to 250 nm because this can result in GSMs where layer (iii) does not interfere with the ability of the DL to discriminate between polar and non-polar gases.

Layer (iii) typically acts as an anti-crack layer and serves the purpose of reducing damage to the DL (layer (ii)) when the gas separation membrane is used under high temperatures and/or pressures.

The gas permeance of layer (iii) is preferably as high as possible. The ability of layer (iii) to discriminate between gases is unimportant and such ability is preferably low. More preferably layer (iii) has an average thickness in the range 70 to 250 nm.

The optional protective layer (“PL”) (iv) is typically located on layer (iii). The PL (iv) may be made of the components described above in relation to the GL and may have the same composition as the GL or a different composition to the GL. The function of the PL (iv) is to protect layer (ii) and (iii).

Preferably the PL (iv) has an average thickness in the range of 100 to 4,000 nm, more preferably 1,000 and 3,000 nm.

The gas separation membranes of the present invention may be packaged and supplied commercially to companies who assemble gas separation modules, e.g. for their own use or for onward sale.

According to a third aspect of the present invention there is provided a gas separation module comprising one or more gas separation membranes according to the first aspect of the present invention.

The gas separation modules of the present invention preferably further comprise a feed carrier and a permeate carrier, optionally wound onto a perforated tube

According to a fourth aspect of the present invention there is provided use of a gas separation membrane according to the first aspect of the present invention or a gas separation module according to the third aspect of the present invention for separating gases and/or for purifying a feed gas.

The gas separation membranes and modules of the present invention are particularly useful for the separation of a feed gas containing a target gas into a gas stream rich in the target gas and a gas stream depleted in the target gas. For example, a feed gas comprising polar and non-polar gases may be separated into a gas stream rich in polar gases and a gas stream depleted in polar gases. In many cases the membranes have a high permeability to polar gases, e.g. CO₂, H₂S, NH₃, SOₓ, and nitrogen oxides, especially NOₓ, relative to non-polar gases, e.g. alkanes, H₂, and N₂. Thus the polar gas is preferably CO₂, H₂S, NH₃, SOₓ, a nitrogen oxides or two or more thereof in combination. The non-polar gas is preferably N₂, H₂, an alkane or two or more thereof in combination.

Preferably the polar and non-polar gases are gaseous when at 25° C.

The target gas may be, for example, a gas which has value to the user of the module or element and which the user wishes to collect. Alternatively the target gas may be an undesirable gas, e.g. a pollutant or ‘greenhouse gas’, which the user wishes to separate from a gas stream in order to meet a product specification or to protect the environment.

The modules and membranes of the present invention are particularly useful for purifying natural gas (a mixture which predominantly comprises methane) by removing polar gases (CO₂, H₂S); for purifying synthesis gas; and for removing CO₂ from hydrogen and from flue gases. Flue gases typically arise from fireplaces, ovens, furnaces, boilers, combustion engines and power plants. The composition of flue gases depend on what is being burned, but usually they contain mostly nitrogen (typically more than two-thirds) derived from air, carbon dioxide (CO₂) derived from combustion. Flue gases also contain a small percentage of pollutants such as particulate matter, carbon monoxide, nitrogen oxides and sulphur oxides. Recently the separation and capture of CO₂ has attracted attention in relation to environmental issues (global warming).

The modules and membranes of the present invention are particularly useful for separating the following: a feed gas comprising CO₂ and N₂ into a gas stream richer in CO₂ than the feed gas and a gas stream poorer in CO₂ than the feed gas; a feed gas comprising CO₂ and CH₄ into a gas stream richer in CO₂ than the feed gas and a gas stream poorer in CO₂ than the feed gas; a feed gas comprising CO₂ and H₂ into a gas stream richer in CO₂ than the feed gas and a gas stream poorer in CO₂ than the feed gas, a feed gas comprising H₂S and CH₄ into a gas stream richer in H₂S than the feed gas and a gas stream poorer in H₂S than the feed gas; and a feed gas comprising H₂S and H₂ into a gas stream richer in H₂S than the feed gas and a gas stream poorer in H₂S than the feed gas.

The modules and membranes of the present invention are particularly useful for separating ‘dirty’ a feed gas comprising a polar gas, a non-polar gas and a hydrocarbon containing at least two (e.g. 2 to 7) carbon atoms into a permeate gas and a retentate gas, one of which is enriched in the polar gas and the other of which is depleted in the polar gas.

The invention will now be illustrated by the following, non-limiting examples in which all parts and percentages are by weight unless specified otherwise.

### EXAMPLES

TABLE 1

| | Components | | |
|---|---|---|---|
| Feed gas | CO₂ | CH₄ | n-C₄H₁₀ |
| vol % | 13.00 | 86.00 | 1.00 |

The performance properties of the gas separation membranes of the present invention were measured using the following techniques:

### (A) Permeance

The feed gas having the composition described in Table 1 above was passed through the simplified gas separation composite shown in Table 1 under test at 40° C. at a gas feed pressure of 6000 kPa. The flux of CO₂ and n-C₄H₁₀ and CH₄ through the simplified gas separation composites was measured using a gas permeation cell with a measurement diameter of 2.0 cm.

The permeance (Qi) of CO₂ and n-C₄H₁₀ and CH₄ was determined after 5 minutes continuous use on gas separation composites using the following equation:

Qᵢ=(θ_{Perm}·X_{Perm,i})/(A·(P_{Feed}˜X_{Feed,I}−P_{Perm}·X_{Perm,i}))

wherein:
Qᵢ=Permeance of the relevant gas (i.e. i is CO₂ or C₄H₁₀ or CH₄) (m³(STP)/m²·kPa·s);
θ_{Perm}=Permeate flow rate (m³(STP)/s);
X_{Perm,i}=Volume fraction of the relevant gas in the permeate gas;
A=Membrane area (m²);
P_{Feed}=Feed gas pressure (kPa);
X_{Feed,i}=Volume fraction of the relevant gas in the feed gas;
P_{Perm}=Permeate gas pressure (kPa); and

STP is standard temperature and pressure, which is defined here as 25.0° C. and 1 atmosphere pressure (101.325 kPa).

The (Qᵢ) can be determined by 1 GPU=1×10⁻⁶cm³(STP)/(s·cm²·cmHg).

The permeance of CO₂ above 25 GPU was evaluated as acceptable and below or equal to 25 GPU was deemed to be unacceptable.

### (B) Selectivity

The selectivity (CO₂/C₄H₁₀ and CO₂/CH₄; αCO₂/C₄H₁₀ and αCO₂/CH₄) of each gas separation composite under test for the gas mixture described in Table 2 was calculated from QCO₂ and Qn-C₄H₁₀ calculated as described above based on following equations:

αCO₂/n-C₄H₁₀=QCO₂/Qn-C₄H₁₀;

αCO₂/CH₄=QCO₂/QCH₄

wherein QCO₂, QCH₄ and Qn-C₄H₁₀ were determined by the method described in step (A) above.

An αCO₂/n-C₄H₁₀ value of 100 or higher was deemed to be acceptable and an αCO₂/n-C₄H₄ value of below 100 was deemed to be unacceptable.

An αCO₂/CH₄ value of 26 or higher was deemed to be acceptable and an αCO₂/CH₄ value of below 26 was deemed to be unacceptable.

### (C) Humidity Durability

Humidity durability was determined as follows:

The gas separation membranes under test were placed in a climate chamber at 40° C. and 90% humidity for 24 hours. Then selectivity was measured using the method (B) described above. In case the CO₂/CH₄ selectivity difference (in value) of the GSM before and after humidity treatment is lower than 5 the example was deemed to be acceptable (OK); in case the difference was 5 or higher the example was deemed to be unacceptable (NG).

### (D) Measurement of the Amount of Monovalent Metal Ions Present in the Porous Support

In the following Examples, the amount of monovalent metal ions present in the porous support was determined as follows:

A sample of the porous support under investigation of size 8.8 cm² was dissolved in concentrated (70%) nitric acid (5 cm³) by heating in a microwave (Anton Paar 3000 microwave) at 1200 W for 15 minutes. The dissolved sample was diluted with milli-Q (45 cm³) to give a clear solution (total volume 50 cm³). The content of monovalent metal ions in the clear solution was determined by multielemental inorganic analyses using a Perkin-Elmer 5300DV ICP-OES fitted with a concentric Type K nebulizer and a Cyclonic spray chamber. The concentration of monovalent metal ions in the clear solution was calculated as follows:

First the increase/decrease of the element signal (K) per wavelength was calculated:

K=(c_{add}−c)/c_{std}*100%
K=correction factor increase/decrease element concentration;
c_{add}=concentration of the sample+standard addition, in mg/l;
c=concentration of the element analysed in the calibration line, in mg/l;
c_{std}=concentration of the added standard solution, in mg/l;

Then: Cₑ=(c−c_{bl})*100/K*50/a*10
Cₑ=concentration of the element;
c_{bl}=concentration of the element in the blank solution, in mg/l;
a=surface area of sample in cm².
   Then the concentration of monovalent metal ions in the porous support in mg/m² was obtained by adding up all values CE for each element e.g. Na⁺, K⁺, Li⁺, Cs⁺ and Li⁺.

### Preparation of the Gas Separation membranes

The following materials were used to prepare the gas separation membranes:
PAN1 is a porous support having an average thickness of 170-180 μm comprising a PET nonwoven support (140-150 μm thick) having a porous polyacrylonitrile layer. PAN1 was obtained from Microdyn-Nadir GmbH, Germany, under the trade name UA100T and comprised 3.5 mg/m² of Na⁺ (sodium ions).
PAN2 is a porous support having an average thickness of 180-190 μm comprising a PET nonwoven support (140-150 μm thick) having a porous polyacrylonitrile layer. PAN2 was obtained from GMT Membrantechnik GmbH, Germany under the trade name L14. PAN2 comprised 25 mg/m² monovalent ions (22 mg/m² of sodium ions and 3 mg/m² of potassium ions). PAN2 is a Comparative Example due to it's high content of monovalent metal ions.
PAN3 was obtained by immersing PAN1 in 2.5 g/I NaHCO3 solution at 30 C for 3 hours and then rinsing with pure water and drying for 3 hours at 60 C. The resultant PAN3 comprised 25 mg/m2 of sodium ions and 0.3 mg/m2 potassium ions. PAN3 is a Comparative Example due to it's high content of monovalent metal ions.
X-22-162C is a dual end reactive silicone having carboxylic acid reactive groups, a viscosity of 220 mm²/s and a reactive group equivalent weight of 2,300 g/mol, from Shin-Etsu Chemical Co., Ltd. (MWT 4,600) (I is an integer).

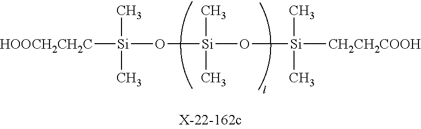

DBU is 1,8-diazabicyclo[5.4.0]undec-7-ene from Sigma Aldrich.
UV-9300 is SilForce™ UV-9300 from Momentive Performance Materials Holdings having an epoxy equivalent weight of 950 g/mole oxirane (MWT 9,000, determined by viscometry)) (m and n are integers).

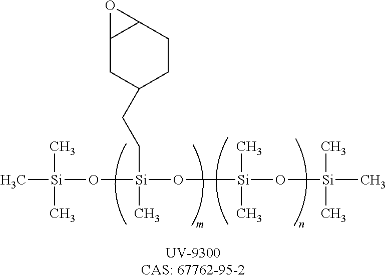

Teflon™ AF 2400 is poly[4,5-difluoro-2,2-bis(trifluoromethyl)-1,3-dioxole-co-tetrafluoroethylene] having 60 to 90 mol % of dioxole, preferably 87 mol % of dioxole, available from Chemous.
Teflon™ AF 1600 is poly[4,5-difluoro-2,2-bis(trifluoromethyl)-1,3-dioxole-co-tetrafluoroethylene] having 50 to 80 mol % of dioxole, preferably 65 mol % of dioxole, available from Chemous.
HYFLON™ AD 60 is amorphous poly(tetrafluoroethylene-co-2,2,4-trifluoro-5-trifluoromethoxy-1,3-dioxole), preferably having a proportion of ether functionalities of 30 to 90 mol %, preferably 60 mol %, available, for example, from Solvay.
Fluorolink™ S-1 is a silane-functional perfluoropolyether from Solvay.
D4484 is 1,1,1,2,2,3,4,5,5,5-Decafluoro-3-methoxy-4-(trifluoromethyl)pentane from Tokyo Chemical Industry.
I0591 is 4-isopropyl-4′-methyldiphenyliodoniumtetrakis(pentafluorophenyl) borate (C₄₀H₁₈BF₂₀I) from Tokyo Chemical Industries N.V. (Belgium)

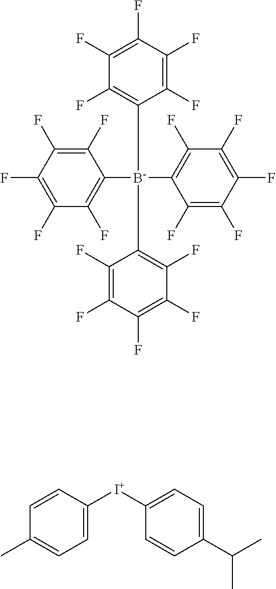 [SMILES: Fc1c(F)c(F)c([B-](c2c(F)c(F)c(F)c(F)c2F)(c2c(F)c(F)c(F)c(F)c2F)c2c(F)c(F)c(F)c(F)c2F)c(F)c1F ; Cc1ccc([I+]c2ccc(C(C)C)cc2)cc1]

Ti(OiPr)₄ is titanium (IV) isopropoxide from Dorf Ketal Chemicals (MWT 284).
n-Heptane is n-heptane from Brenntag Nederland BV.
MEK is 2-butanone from Brenntag Nederland BV.
QM1 is VQM-146, a vinyl functional QM resin dispersion in a dual end vinyl functional polydimethylsiloxane from Gelest Inc. having the following formula:

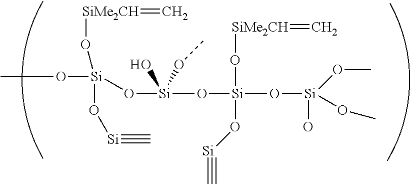

MIBOH is 2-methyl-3-butyn-2-ol from Sigma-Aldrich.
HMS-301 is a poly(methylhydrosiloxane-co-dimethylsiloxane) from Gelest Inc.
PT is SIP6831.2, a platinum(0)-1,3-divinyl-1,1,3,3-tetramethyldisiloxane complex in Xylene from Gelest Inc.

### Preparation of Membrane Sheet

### Stage a) Preparation of a Partially Cured Polymer (“PCP Polymer”)

The components UV-9300, X-22-162C and DBU were dissolved in n-heptane in the amounts indicated in Table 5 and maintained at a temperature of 91° C. for 168 hours. The resultant polymer (PCP Polymer), had a Si content (meq/g polymer) of 12.2 and the resultant solution of PCP Polymer had a viscosity of 125 m Pas at 25.0° C.

TABLE 5
Ingredients used to Prepare PCP Polymer

| Ingredient | Amount (w/w %) |
|---|---|
| UV-9300 (w/w %) | 46.395 |
| X-22-162C (w/w %) | 13.596 |
| DBU (w/w %) | 0.009 |
| n-Heptane (w/w %) | 40.000 |

### Stage b) Preparation of Radiation Curable Composition(“C”)

The solution of PCP Polymer arising from the Stage a) was cooled to 20° C. and diluted using n-heptane to give the PCP Polymer concentration indicated in Table 6 below. The solution was then filtered through a filter paper having a pore size of 2.7 μm. The photoinitiator (I0591) and a metal complex (Ti(OiPr)₄) were then added in the amounts (wt/wt %) indicated in Table 6 to give Curable Composition C. The amount of Ti(OiPr)₄ present in Curable Composition C corresponded to 55.4 μmol of Ti(OiPr)₄ per gram of PCP Polymer. Also the molar ratio of metal:silicon in Curable Composition C was 0.0065.

TABLE 6
Ingredients of Curable Composition C

| Ingredient | Amount (wt/wt %) |
|---|---|
| PCP Polymer | 10.000 |
| I0591 | 0.105 |
| Ti(OiPr)₄ | 0.226 |
| DBU | 0.001 |
| MEK | 2.008 |
| n-Heptane | 87.660 |

Curable Composition C was used to prepare the gutter layer(“GL”) and the protective layer(“PL”) of the membranes, as described in more detail below.

### Stage c) Preparation of a Resin Precursor Composition

The components mentioned in Table 7 below were added in the indicated concentrations and stirred for 5 minutes at room temperature to prepare the curable polysiloxane polymer solution. The solution was then filtered through a polypropylene filter having a pore size of 0.5 μm.

TABLE 7
Ingredients for a resin precursor composition

| Ingredient | Amount (wt/wt %) |
|---|---|
| QM1 | 2.294 |
| HMS-301 | 0.206 |
| PT | 0.0075 |
| MIBOH | 0.0075 |
| n-Heptane | 97.485 |

### Stage d) Preparation of Fluorinated Polymer Compositions (“D1” and “D2” and “D3”)

Fluorinated polymer (D1:Teflon™ AF 2400 or D2:Teflon™ AF 1600 or D3:Hyflon™ AD60) was mixed with a solvent (D4484, 1,1,1,2,2,3,4,5,5,5-decafluoro-3-methoxy-4-(trifluoromethyl)pentane from Tokyo Chemical Industry). Then heated up to 90° C. and stirred at 90° C. for 30 hours in a closed pressure durable bottle. Then the clear solution was cooled to 20° C. Fluorolink™ S-10 was added, then stirred for 1 hr at 20° C. The concentrations of the various components was as indicated in Table 8 below. The solution was then filtered through a filter paper having a pore size of 2.7 μm.

TABLE 8
Preparation of Composition D1-D3

| Ingredient | Amount (wt/wt %) |
|---|---|
| Fluorinated Polymer | 0.95 |
| Fluorolink ™ S-10 | 0.05 |
| D4484 | 99.00 |
| Viscosity (mPas at 25° C.) | 95 |

Composition D1-D3 were used to prepare the fluorinated polymer layer(“FPL”) of the membranes, as described in more detail below.

### Step i. Preparation of the Porous Sheet Material (“PSM”) Carrying a Gutter Layer (GL) (PSM-GL)

Curable Composition C was applied to a PAN1 porous support layer for Examples 1 to 7, on PAN2 porous support layer for Comparative Examples 1 to 3 and on PAN3 porous support layer for comparative Example 4 by a meniscus dip coating at a speed of 10 m/min and the coated porous sheet material was then irradiated at an intensity of 16.8 kW/m (70%) using a Light Hammer LH10 from Fusion UV Systems fitted with a D-bulb. The resultant product comprised porous sheet material and a polysiloxane (PDMS) gutter layer of dry thickness 600 nm. The gutter layer comprised a metal complex and dialkylsiloxane groups. The gutter layer thickness was verified by cutting through the product and measuring the thickness from the surface of the porous sheet material outwards by SEM.

### Step ii. Preparation of the Resin Precursor Layer (RPL) on the GL for Example 7. (PSM+GL+RPL)

The resin precursor composition described in Table 7 was applied to the GL of the product of step (i) (porous sheet material+GL) (as specified in table 9 below) using a pre-metered slot-die coating at a speed of 10 m/min and the resulting product was then heated to a temperature of 60° C. for a period of 10 minutes. The resulting product comprised the porous sheet material (PSM)+a gutter layer (GL)+a resin precursor layer (RPL) in that order. The resin precursor layer had a thickness of 150 nm, as verified by cutting through the PSM+GL+RPL composite and measuring the thickness from the surface of the PSM outwards by SEM, the results of which is listed in Table 9 below.

### Step iii. Formation of the Discriminating Layer (DL) (PSM+GL(+RPL)+DL)

The products of step i. and step ii. were each independently exposed to an atmospheric glow discharge (APG) plasma for the inventive Examples 1 to 5, 7 and 8 and to a vacuum plasma (LPG) treatment for inventive Example 6.

For the inventive Examples 1 to 5, 7 and Comparative Examples 1 to 4 an atmospheric plasma device was used as already described by applicant in EP1917842, FIG. 5 with carrier gas conditions of an oxygen flow rate of 0.5 dm³ (STP)/min and an argon flow rate of 20 dm³ (STP)/min were set, and then a plasma treatment was performed as an oxygen atom permeating treatment at an input power of 0.9 J/cm².

For the low pressure treatment a desktop vacuum plasma device (manufactured by YOUTEC Corporation), carrier gas conditions of an oxygen flow rate of 20 cm³ (STP)/m in and an argon flow rate of 100 cm³ (STP)/m in were set, and then a plasma treatment was performed as an oxygen atom permeating treatment at a vacuum degree of 30 Pa and an input power of 200 W for a treatment time of 10 seconds (=2.82 J/cm²) at 20° C. for Example 6.

### Step iv. Formation of Layer (“FPL”) (iii) (PSM+GL(+RPL)+DL+FPL)

The products prepared in step iii. (PSM+GL+RPL+DL) were coated with the fluorinated polymer composition D1 for inventive Examples 1 to 3, 6 to 7 and Comparative Examples 1 to 4 or fluorinated polymer composition D2 for inventive Example 4 or fluorinated polymer composition D3 for inventive Example 5 by a meniscus dip coating at a speed of 10 m/min and dried. The fluorinated polymer layer (iii) (FPL) thickness was verified by cutting through the sheet material and measuring the thickness from the surface of the porous support material outwards by SEM.

### Step v. Formation of a Gas Separation Membrane (PSM+GL(+RPL)+DL+FPL+PL) for all Examples Except Example 2 and Comparative Example 2

A gas separation membrane comprising a protective layer (iv) was prepared as follows:
Curable composition C having the formulation described above was applied to all the membrane examples arising from step iii. above by a meniscus dip coating at a speed of 10 m/min. The coated membranes were then cured by irradiating at an intensity of 24 kW/m using a Light Hammer LH10 from Fusion UV Systems fitted with a D-bulb. The resultant gas separation membranes comprised PSM+GL(+RPL)+DL+FPL+PL. The average thicknesses of each protective layer (iv) was 2400 nm, as measured by SEM.

Table 9 shows the composition of each gas separation membrane example in more detail. Gas separation membrane examples were evaluated using the humidity durability test described above and evaluating the selectivity before and after humidity treatment. The results are shown in Table 10. It is clear that the inventive Examples maintained good permselectivity even under after exposure to high humidity conditions.

TABLE 9

| | | | | DL | | | |
|---|---|---|---|---|---|---|---|
| | | | | | M atomic % | FPL | |
| | | GL and RPL | | Plasma type | Of Formula | Type | PL |
| | PAN | (thickness) | | (energy) | (1) Groups | (thickness) | (thickness) |
| Ex. 1 | PAN1 | GL | | APG | 12 | D1 | (2400 nm) |
| | | (600 nm) | | (0.9 J/cm2) | | (100 nm) | |
| Ex. 2 | PAN1 | GL | | APG | 12 | D1 | — |
| | | (600 nm) | | (0.9 J/cm2) | | (100 nm) | |
| Ex. 3 | PAN1 | GL | | APG | 12 | — | (2400 nm) |
| | | (600 nm) | | (0.9 J/cm2) | | | |
| Ex. 4 | PAN1 | GL | | APG | 12 | D2 | (2400 nm) |
| | | (600 nm) | | (0.9 J/cm2) | | (100 nm) | |
| Ex. 5 | PAN1 | GL | | APG | 12 | D3 | (2400 nm) |
| | | (600 nm) | | (0.9 J/cm2) | | (100 nm) | |
| Ex. 6 | PAN1 | GL | | LPG | 12 | D1 | (2400 nm) |
| | | (600 nm) | | (2.82 J/cm2) | | (100 nm) | |
| Ex. 7 | PAN1 | GL | RPL | APG | 14 | D1 | (2400 nm) |
| | | (600 nm) | (150 nm) | (0.9 J/cm2) | | (100 nm) | |

| | | | | | | |
|---|---|---|---|---|---|---|
| co- | PAN2 | GL | APG | 12 | D1 | (2400 nm) |
| Ex. 1 | | (600 nm) | (0.9 J/cm2) | | (100 nm) | |
| co- | PAN2 | GL | APG | 12 | D1 | — |
| Ex. 2 | | (600 nm) | (0.9 J/cm2) | | (100 nm) | |
| co- | PAN2 | GL | APG | 12 | — | (2400 nm) |
| Ex. 3 | | (600 nm) | (0.9 J/cm2) | | | |
| co- | PAN3 | GL | APG | 12 | D1 | (2400 nm) |
| Ex. 4 | | (600 nm) | (0.9 J/cm2) | | (100 nm) | |

TABLE 10

| | | CO₂/CH₄ selectivity difference |
|---|---|---|
| | CO₂/CH₄ selectivity | (Before − after) humidity |
| | before humidity treatment | treatment |
| | OK: >25 | OK: <5 |
| Ex. 1 | OK | OK |
| Ex. 2 | OK | OK |
| Ex. 3 | OK | OK |
| Ex. 4 | OK | OK |
| Ex. 5 | OK | OK |
| Ex. 6 | OK | OK |
| Ex. 7 | OK | OK |
| co-Ex. 1 | OK | (NG) |
| co-Ex. 2 | OK | (NG) |
| co-Ex. 3 | OK | (NG) |
| co-Ex. 4 | OK | (NG) |

NG = Not good; OK = Good.

1-23. (canceled)

24. A gas separation membrane
comprising the following layers:
(i) a porous support layer comprising a porous support material and a polysiloxane gutter layer (GL) and/or a precursor layer comprising a crosslinkable polysiloxane polymer;
(ii) a discriminating layer formed by plasma treatment of the surface of said polysiloxane gutter layer (GL) and/or precursor layer comprising groups of the Formula (1):
M—(O—)ₓ Formula (1)
wherein:
M is a metal or metalloid atom;
O is an oxygen atom; and
x has a value of at least 4;
optionally (iii) a layer which comprises a fluorinated polymer; and
optionally (iv) optionally a protective layer;
wherein:
(a) the porous support layer (i) comprises at least 0.1 mg/m² and less than 10 mg/m² of monovalent metal ions;
(b) the discriminating layer (ii) comprises a surface comprising at least 10 atomic % of M of Formula (1) groups, wherein M is as hereinbefore defined; and
(c) when layer (iii) is present, layer (ii) is located between layers (i) and (iii).

25. The gas separation membrane according to claim 24 wherein layer (ii) further comprises one or more compounds of Formula (2):
M—(O—)_{z} Formula (2)
wherein:
M is a metal or metalloid atom;
O is an oxygen atom; and
z has a value of 1, 2 or 3.

26. The gas separation membrane according to claim 24 wherein each M independently is silicon, titanium, zirconium or aluminium.

27. The gas separation membrane according to claim 24 wherein the discriminating layer comprises a surface comprising less than 50 atomic % of M of Formula (1) groups.

28. The gas separation membrane according to claim 24 wherein M is silicon and the discriminating layer comprises a surface comprising 10 to 30 atomic % of M of Formula (1) groups.

29. The gas separation membrane according to claim 24 wherein the gutter layer is located between the support layer and the resin precursor layer and the resin precursor layer is located between the gutter layer and layer (ii).

30. The gas separation membrane according to claim 24 wherein layer (iii) has an average thickness of 1 to 150 nm.

31. The gas separation membrane according to claim 24 wherein layer (ii) has been formed by a process comprising use of atmospheric glow discharge plasma.

32. The gas separation membrane according to claim 24 wherein layer (iv) is present and comprises a polysiloxane.

33. A gas separation module comprising a gas separation membrane according to claim 24.

34. A method of using a gas separation membrane according to claim 24 for separating gases and/or for purifying a feed gas.

35. A process for forming a gas separation membrane according to claim 24.

36. The process according to claim 35 wherein the discriminating layer (ii) is formed by a plasma deposition process using an atmosphere comprising air or oxygen.

37. A method of using a gas separation module according to claim 33 for separating gases and/or for purifying a feed gas.
